(19) United States
(12) Patent Application Publication
(10) Pub. No.: US 2008/0004554 A1
(43) Pub. Date: Jan. 3, 2008

(54) Pressure point therapy tool

(76) Inventor: Stacey D. Smith, Malibu, CA (US)

Correspondence Address: Stacey D. Smith;c/o Law Offices of Perry C. Wander, Suite 1000, 9777 Wilshire Blvd., Beverly Hills, CA, 90212, US

(21) Appl. No.: 11/789,068

(22) Filed: Apr. 24, 2007

Related U.S. Application Data
(60) Provisional application No. 60/817,055, filed on Jun. 28, 2006.

(51) Int. Cl. A61H 7/00

(52) U.S. Cl. 601/134; 601/138

(57) ABSTRACT

A pressure point therapy tool for performing various methods of pressure point therapy comprised of a tetrahedron with substantially planar surfaces and rounded apexes. The rounded apexes are used to apply pressure to myofascial trigger points, acupressure points, or reflexology points.

### CROSS-REFERENCE TO RELATED APPLICATIONS

This application claims the benefit of U.S. Provisional Application No. 60/817,055, filed Jun. 28, 2006.

### STATEMENT REGARDING FEDERALLY SPONSORED RESEARCH OR DEVELOPMENT

NOT APPLICABLE

### THE NAMES OF THE PARTIES TO A JOINT RESEARCH AGREEMENT

NOT APPLICABLE

### INCORPORATION-BY-REFERENCE OF MATERIAL SUBMITTED ON A COMPACT DISC

NOT APPLICABLE

### BACKGROUND OF THE INVENTION

1. Field of the Invention

The present invention relates the field of deep pressure healing, massage, and chiropractic care, and more specifically to myofascial trigger point therapy, acupressure, and reflexology point therapy.

2. Description of the Related Art

Many people suffer from muscle soreness, stiffness and tension. Often, this is caused by a variety of factors such as a direct injury or trauma, overuse, poor posture, and even stress. These factors cause restriction in the fascia, a fibrous connective tissue which surrounds muscles and provides support and structure to the body. The fascia and muscles form an interconnected network, and restriction or tightness to fascia can lead to overcompensation and pain other places in the body.

One recognized method for treating these types of injuries and managing pain is massage therapy. Deep tissue techniques have been developed to enable more focused massage work, focusing on a specific joint or muscle. Deep tissue massage is typically performed by a trained professional. By performing deep tissue techniques, the professional accesses deeper layers of the soft tissue than basic massage techniques. These therapy techniques have been refined into a technique known as myofascial release or myofascial therapy. Myofascial therapy targets the massage on the fascia by applying initial pressure at a particular location and then gently stretching the fascia.

Trigger point therapy focuses and applies the pressure at a particular trigger point on the body. Trigger points are areas in the human body that have been observed to be primary sources of myofascial pain and restriction. Trigger points cause pain locally or in other locations in the body along associated nerve pathways. Treatment of the affected trigger point can relieve pain at the particular area as well as throughout the affected portion of the muscular network.

Acupressure therapy is similar to myofascial trigger point therapy. Acupressure is performed by similarly applying pressure on different points on the surface of the body. However, acupressure is based upon the use of acupuncture points as opposed to trigger points. There is some overlap between acupuncture points and trigger points, and the primary difference between myofascial trigger point therapy and acupressure therapy is the point on the body targeted. The method and desired results are essentially the same.

Reflexology is another form of therapy that involves applying pressure on the body to relieve stress and restriction locally and throughout the body. Reflexology points are locations in the hands and feet along the nervous system. Pressure is applied to these points to relieve stress and pain.

Myofascial trigger point therapy, acupressure, and reflexology all involve direct application of pressure on the surface of the human body. These forms of therapy, collectively referred to as pressure point therapy, are commonly performed by a trained individual, such as a massage therapist or physical therapist. The costs associated with having therapy performed by a trained individual are not insubstantial, and the cost can become prohibitive if routine visits are necessary. However, the nature of pressure therapy is such that performing it autonomously is inefficient and very difficult. This is because many of the pressure points are in locations that are difficult for an individual to access with their own hands or are accessible only by contorting the body into a position where treatment cannot be effectively rendered or received. Additionally, trained individuals generally perform pressure point therapy using a varying combination of fingers, hands, elbows, or forearms. Although parts of the human body can be very solid, the human form is inherently malleable and fluid and therefore it is difficult for even the most trained professional to apply consistent and focused pressure in all circumstances. Therefore, it is desirable that a tool exist to enable individuals to effectively perform pressure point therapy autonomously or enhance and improve professional administration of pressure point therapy methods.

### BRIEF SUMMARY OF THE INVENTION

The present invention provides a pressure point therapy tool that can be used by individuals to perform various pressure point therapy methods autonomously or on other individuals, thereby enabling more effective pressure point therapy and reducing the costs that would be incurred if consulting professionally trained therapists were the only alternative. The invention comprises a tetrahedron with substantially planar surfaces and rounded apexes. The invention is scalable to various sizes such that a larger scaled version is used to apply pressure point therapy to larger muscle groups while smaller dimensions are more effective for smaller muscle groups and trigger points.

The invention can be used as a handheld tool, or can be placed on a surface which can then be used to apply pressure by manipulating the individual's body relative to the placement of the tool. Pressure can be applied by using either the rounded apexes or the surfaces of the tool. The tool can also be used along the length of a muscle and is not limited to pressure point therapy.

### BRIEF DESCRIPTION OF THE DRAWINGS

FIG. 1A is a side perspective view of the preferred embodiment of the present invention.

FIG. 1B is a top perspective view of the preferred embodiment of the present invention.

FIGS. 2A-2D illustrate use of the preferred embodiment of the present invention.

### DETAILED DESCRIPTION OF THE INVENTION

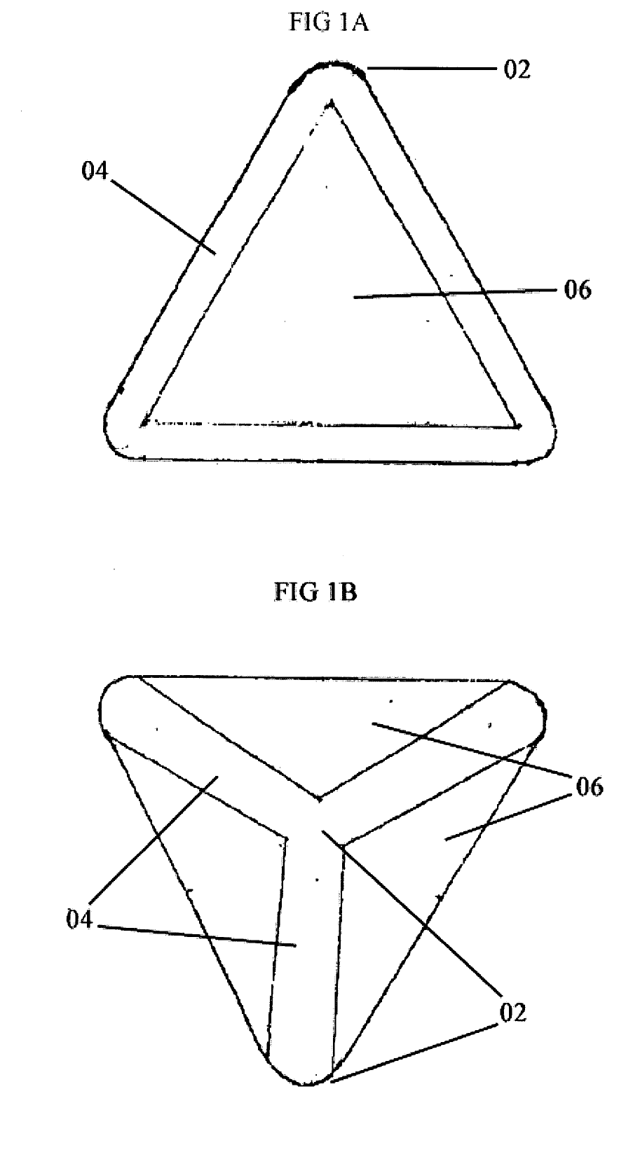

The preferred embodiment of the invention is shown in FIG. 1. FIG. 1A shows a side perspective view of the preferred embodiment while FIG. 1B shows a top perspective view. The pressure point therapy tool of the preferred embodiment is a triangular four-sided pyramid. The preferred embodiment is a regular tetrahedron, wherein the four triangular faces 06 are substantially equilateral. In the preferred embodiment, the points or apexes 02 where the individual points of the four triangular faces 06 meet are rounded, such that a cross-section of these rounded points 02 is substantially spherical. The six edges 04 of the tool where the sides of the four triangular faces 06 meet are also rounded in the preferred embodiment. The invention does not require all points 02 and edges 04 to be rounded, however, this makes the tool more comfortable when held in the hand and allows interchangeable use of any point 02 or edge 04 to apply pressure. Rounded points 02 allow a greater surface area of the tool to contact the surface of body in a planar fashion when pressure is applied, which makes therapy more effective and causes less discomfort when compared to points that have not been smoothed or rounded.

The invention can be made of any material that can provide pressure without fracturing, such as polyethylene, polypropylene, vinyl, nylon, rubber, leather, and various other composite materials. In the preferred embodiment, the invention is composed of silicon. The invention is scalable in order to allow more effective therapy. The preference of the inventor is to use a version of the preferred embodiment wherein the length of the edges 04 of the tool are approximately 2.75 inches for performing therapy on larger muscle groups, and a smaller version wherein the length of the edges 04 of the tool are approximately 1.75 inches. It will be apparent to one skilled in the art that the present invention can be modified depending on the needs and goals of the person applying the therapy (i.e. varying the dimensions and shape of the tool, by adding texture to the surface, etc.), however, the preferred embodiment described is believe to be optimal and accommodates a wide variety of uses.

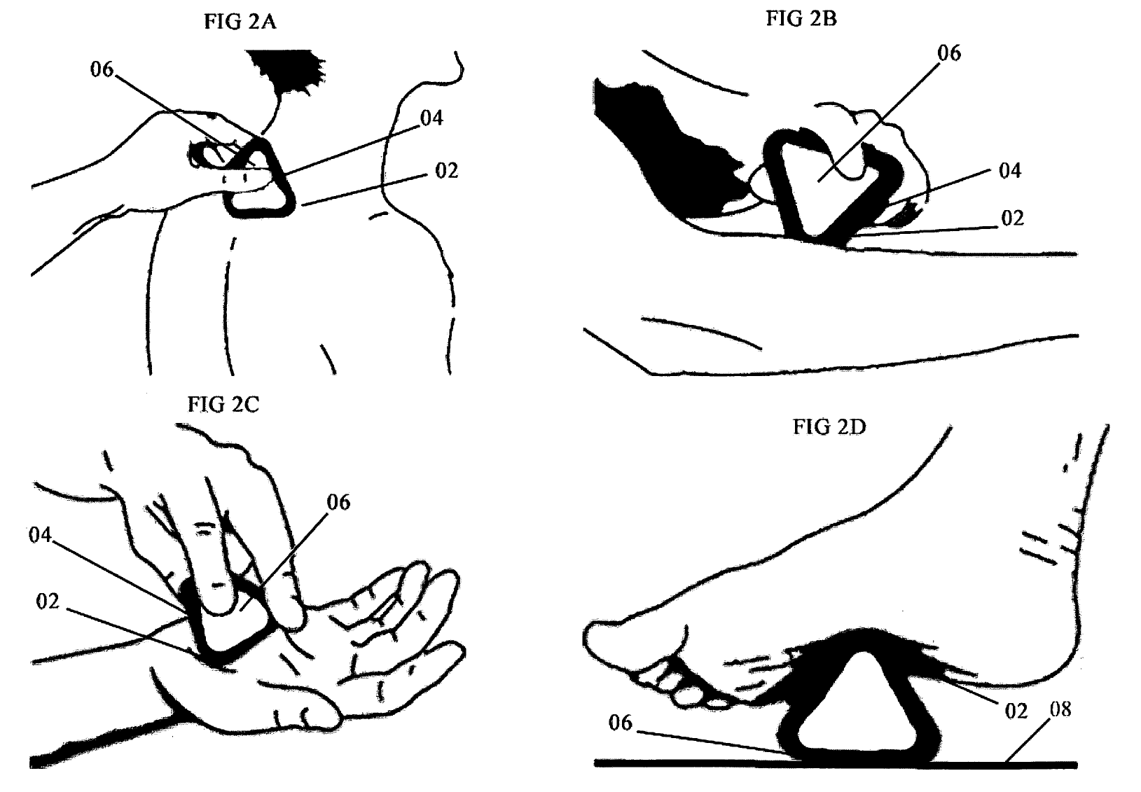

FIGS. 2A-2D illustrate use of the preferred embodiment of the present invention. FIG. 2A shows use of the pressure point therapy tool by an individual, such as a trained professional, to apply pressure to the upper back of another individual. The individual applying pressure grasps the pressure point therapy tool as desired and applies to the targeted area. In FIG. 2A, pressure is applied using one of the points 02 of the tool, however, an edge 04 or a face 06 of the tool could be used depending on the needs of the individual receiving therapy. The other individual applying pressure can then apply pressure in various manners as desired, such as perpendicular to the surface of the body, in a planar direction to the body, in a circular fashion, etc.

FIG. 2B shows the use of the present invention as a personal handheld tool. Here, an individual can perform pressure point therapy on themselves without the assistance of another individual. Again, the individual can apply pressure using a point 02, edge 04, or face 06 of the tool as desired. FIG. 2C shows another use of the present invention as a personal handheld tool. In FIG. 2C, the individual is applying pressure to a reflexology point located in the palm of the hand using one of the points 02 on the tool. The use of a smaller scale version of the preferred embodiment with smaller dimensions is better suited for applying pressure to smaller muscle groups and reflexology points in the hands and feet.

FIG. 2D illustrates the use of another solid body to apply pressure. One of the surfaces 06 of the tool is placed against a solid surface 08. The surface 08 stabilizes the tool so that an individual can pressure using the point 02 of the tool opposite the surface 06 held against the solid surface 08. FIG. 2D illustrates use of the ground as the solid surface 08 to assist in applying pressure to a reflexology point in the foot. However, other solid surfaces (i.e. a wall) can be used to apply pressure to other locations of the body. The individual can then manipulate and reorient his or her position to enable the solid surface 08 to apply pressure as if the solid surface 08 were a another individual.

I claim:

1. A pressure point therapy tool for use in performing pressure-based therapy methods comprising:
A polyhedron, said polyhedron having at least one surface, said surface further having at least one edge, said edge further having at least one end, said end having a point.

2. A pressure point therapy tool set forth in claim 1, wherein said at least one edge is rounded.

3. A pressure point therapy tool set forth in claim 1, wherein the point of said end of said at least one edge is rounded.

4. A pressure point therapy tool set forth in claim 1, wherein said surface is substantially flat.

5. A pressure point therapy tool set forth in claim 1, wherein said surface is textured.

6. A pressure point therapy tool set forth in claim 1, wherein said polyhedron is a tetrahedron.

7. A pressure point therapy tool as set forth in claim 6, wherein said at least one edge is rounded.

8. A pressure point therapy tool as set forth in claim 7, wherein the point of said end of said at least one edge is rounded.

9. A method of performing pressure point therapy comprising:
Selecting an appropriately sized pressure point therapy tool, said pressure point therapy tool being substantially tetrahedron in shape and having at least one apex, said pressure point therapy tool further having at least one edge, said pressure point therapy tool further having at least one surface;
Identifying a particular location on a human body;
Applying pressure to the selected location using the pressure point therapy tool.

10. The method set forth in claim 9 wherein said location on the human body is a myofascial trigger point.

11. The method set forth in claim 9 wherein said location on the human body is an acupuncture point.

12. The method set forth in claim 9 wherein said location on the human body is a reflexology point.

13. The method set forth in claim 9 wherein pressure is applied using the point of the pressure point therapy tool.

14. The method set forth in claim 9 wherein pressure is applied using the edge of the pressure point therapy tool.

15. The method set forth in claim 9 wherein pressure is applied using the surface of the pressure point therapy tool.

16. The method set forth in claim 9 wherein pressure is applied by placing the pressure point therapy tool on a substantially solid surface and orientating the human body relative to the pressure point therapy tool.
